(19) United States
(12) Patent Application Publication
(10) Pub. No.: US 2015/0064458 A1
(43) Pub. Date: Mar. 5, 2015

(54) FUNCTIONALIZING INJECTION MOLDED PARTS USING NANOFIBERS

(71) Applicant: EATON CORPORATION, Cleveland, OH (US)

(72) Inventors: SOUMAYAJIT SARKAR, Farmington Hills, MI (US); JAVED MAPKAR, Farmington Hills, MI (US); JOHN TRUBLOWSKI, Troy, MI (US); ADRI LAMMERS, Hengelo (NL)

(73) Assignee: EATON CORPORATION, Cleveland, OH (US)

(21) Appl. No.: 14/012,425

(22) Filed: Aug. 28, 2013

(51) Int. Cl. B29C 45/00

(52) U.S. Cl. CPC B29C 45/0013; B29C 45/0005; B29C 2045/0015
USPC 428/339; 264/259; 264/104; 428/457; 428/688; 428/411.1

(57) ABSTRACT

The disclosed concept relates to methods for the manufacture of molded parts having composite nanofibers deposited on a surface of the molded parts. The molded parts are manufactured by utilizing injection molding techniques. The nanofibers are capable of imparting to the molded part functionality, such as but not limited to electrical conductivity, magnetic properties, thermal conductivity, hydrophobicity and superhydrophobicity. The methods include depositing the nanofibers at least partially on an interior surface of a mold, injecting a polymer-containing composition into the mold and extracting a molded part from the mold. A surface of the molded part includes a layer or coating of nanofibers deposited thereon and/or therein. The nanofibers are transferred from the interior surface of the mold to the surface of the molded part. The mold and molded part can include three-dimensional shapes as well as two-dimensional shapes.

### BACKGROUND

1. Field

The disclosed concept pertains generally to fibers and, more particularly, to composite nanofibers. The disclosed concept further pertains to incorporating the composite nanofibers into an injection molding process to impart functionality to molded parts.

2. Background Information

Various conventional techniques are known for producing fibers in nanoscate dimensions. The resultant fibers are typically in the form of a flat, two-dimensional fiber web or mat. These techniques include, but are not limited to, electrospinning and ForceSpinning™ technology.

A typical electrospinning apparatus is illustrated in FIG. 1. As shown in FIG. 1, the electrospinning apparatus includes a syringe I containing a polymer molten mass 2 or a solution. A spinning capillary 3 is located at the tip of the syringe 1, which is coupled with a pole of the voltage-generating arrangement 6 (current supply). By means of an injection pump 9, the polymer molten mass 2 is transported out of the syringe 1 towards the spinning capillary 3, where drops are formed at the tip. The surface tension of the drop of the polymer molten mass 2 or solution coming out of the spinning capillary 3 is overcome by means of an electric field between the spinning capillary 3 and a counter electrode 5. Then, the drop coming out of the spinning capillary 3 deforms and when it reaches a critical electric potential it is drawn to yield a fine filament, the so-called jet. This electrically-charged jet, continuously extracting new polymer molten mass 2 or solution from the spinning capillary 3 is then accelerated in the electric field towards the counter electrode 5. The jet solidifies during its flight towards the counter electrode 5 by means of the evaporation of the solvent or by means of cooling, such that in a short period of time continuous nanofibers 7 are generated, linked with one another, with typical diameters of a few nanometers to several micrometers. These nanofibers 7 are deposited on the template 4 associated with the counter electrode 5 in the form of a web or nonwoven mat. The conductive template 4 serves as a collector and is grounded together with the counter electrode 5. The polymer nanofibers 7 are spun directly on the conductive template 4.

A typical ForceSpinning™ apparatus (which is commercially available from FibeRio® Technology Corporation) is illustrated in FIG. 2. As shown in FIG. 2, the ForceSpinning™ apparatus includes a spinneret 20 having a reservoir 22 containing a liquid state material 24. During operation, the spinneret 20 is rotated centrifugally on an axis 25 at high revolutions per minute creating hydrostatic and centrifugal forces. As the spinneret 20 rotates, the hydrostatic and centrifugal forces push the liquid state material 24 to an outer wall 26 having an orifice 27 located therein. FIG. 2 shows one orifice 27; however, it is contemplated that a plurality of orifices may be formed in the outer wall 26. The liquid state material 24 enters the one or more orifices 27 and is released therefrom. The centrifugal and hydrostatic forces combine to initiate a jet of the liquid state material 24 that impinges against a fiber collector 28 to produce nanofibers 29. In FIG. 2, the fiber collector 28 is positioned to surround only a portion of the spinneret 20; however, it is contemplated that the fiber collector 28 may be positioned to surround up to the entire circumference of the spinneret 20.

The electrostatic force used to create nanofibers in an electrospinning apparatus is replaced by centrifugal forces in the ForceSpinning™ apparatus. The liquid state material can include solutions or molten materials, such as polymer melt Examples of suitable materials include thermoplastic, thermoset resins and ram extruded polymers, such as polytetrafluoroethylene (PTFE). In addition to nanofibers, the apparatus can also produce fibers in the micron or submicron range, In the ForceSpinning™ technology, conductivity and/or electro-static charge are not relevant parameters for the selection of materials to create the fibers and thus, the spectrum of materials to be spun may be broader as compared with electrospinning, e.g., materials with low dielectric constants can be spun into nanofibers without the additional of salt or solvent. The controlled variables for the ForceSpinning™ apparatus are rotational speed of the spinneret, design of the collection system and, and shape and size of the orifices.

It is also known in the art to produce injection molded parts by injecting a polymer material into a mold. In atypical injection molding manufacturing process, heated molten plastic is forced into a mold cavity under pressure. Injection molding consists of a die containing a mold cavity which is formed to the shape of the desired finished component and is in direct fluid communication with a source of molten material, e.g., typically resin but can also include metal. The molten material is forced into the mold cavity and allowed to cool and set. As a result, the molten material conforms to the shape of the cavity. The cooled component is then removed from the mold cavity. This process then can be repeated to produce additional components.

In general, a mold cavity is a negative part being produced. That is, when the cavity is filled with plastic, it is cooled and the plastic becomes solid material resulting in a completed positive component.

Injection pressures can vary and can be in a range from 5,000 to 20,000 psi. Due to the high pressures involved, molds may need to be clamped shut during injection and cooling using clamping forces measured in tons.

Conventional injection molding techniques are capable of producing a large number of components with high levels of precision and consistency. For example, holding tolerances of less than 0.001 inch (0.0025 mm) can be relatively easily accomplished with the appropriate combination of material, component design and mold design. It has been demonstrated that even narrower (i.e., tighter) tolerances can be achieved with additional effort.

There is room for improvement in producing injection molded parts and, in particular, functionalizing the surface of the molded part in order to impart selected properties thereto.

The disclosed concept includes producing composite nanofibers and incorporating them into a matrix, e.g., polymer matrix, to form an injected molded part that has imparted thereto the properties of the composite nanofibers. The conventional processes and apparatus employed include a hybrid of electrospinning or ForceSpinning™ technology and injection molding technology. Further, it would be advantageous for the disclosed concept to be capable of producing three-dimensional molded parts as well as two-dimensional molded parts, and to maintain the transparency of the matrix when formed into the molded part combined with the nanofibers. Furthermore, it would be advantageous to impart to the molded part functionality, such as but not limited to electrical conductivity, magnetic properties, thermal conductivity, hydrophobicity and superhydrophobicity such that these properties exhibited by the molded part are greater than these properties exhibited by the matrix used to form the molded part.

### SUMMARY

These needs and others are met by embodiments of the disclosed concept.

In accordance with one aspect of the disclosed concept, there is provided a method for producing an injection molded part having nanofibers at least partially deposited on an outer surface thereof. The method includes generating nanofibers composed of fiber material selected from polymer, polymer-containing material, metal, metal-containing material, inorganic material, and mixtures thereof, and filler. The method further includes obtaining a mold having a cavity formed therein corresponding to a desired shape of the injection molded part, depositing the nanofibers at least partially on a surface of the cavity, injecting a matrix composition into the cavity wherein the matrix composition includes polymer, allowing the matrix composition to set, transferring the nanofibers at least partially from the surface of the cavity to the outer surface of the injection molded part, and extracting the injection molded part from the mold wherein an outer surface of the injection molded part includes nanofibers at least partially deposited thereon, the nanofibers being at least partially transferred from the surface of the cavity to the outer surface of the molded part.

The mold and injection molded part can be three-dimensional.

The fiber material and the filler can be combined at ambient temperature and pressure.

The fiber material and filler can be combined at a melt temperature of the fiber material.

The filler can exhibit properties selected from electrical conductivity, magnetic properties, thermal conductivity, hydrophobicity, superhydrophobicity and combinations thereof.

The thermal conductivity of the filler can be higher than the thermal conductivity of the fiber material and the matrix composition.

The nanofibers can be deposited on a collector substrate which can be applied to the surface of the cavity and the nanofibers can be at least partially transferred from the collector substrate to the outer surface of the molded part.

The nanofibers can be deposited directly on the surface of the cavity.

The nanofibers can be in the form of a mat. The mat can be porous such that when the matrix composition is transparent the molded part formed therefrom and having the nanofibers deposited thereon is also transparent. The orientation of individual nanofibers in the mat can be selected from randomly oriented, oriented in one direction and oriented in more than one direction.

The nanofibers can be at least partially embedded into the injection molded part.

In accordance with another aspect of the disclosed concept, there is provided an injection molded part including a polymer-containing composition and nanofibers at least partially deposited on an outer surface of the injection molded part, the nanofibers imparting at least one property to the injection molded part. The nanofibers include a fiber material selected from polymer, polymer-containing material, metal, metal-containing material, inorganic material, and mixtures thereof, and filler.

The property can be selected from electrical conductivity, magnetic properties, thermal conductivity, hydrophobicity, superhydrophobicity and combinations thereof.

Further, the injection molded part can be produced by obtaining a mold having a cavity formed therein which corresponds to a desired shape of the injection molded part, depositing the nanofibers at least partially on a surface of the cavity, injecting a matrix composition into the cavity, allowing the matrix composition to set, transferring the nanofibers at least partially from the surface of the cavity to the outer surface of the injection molded part, and extracting the injection molded part from the mold.

The electrical conductivity of the outer surface of the injection molded part can be controlled by selecting specific filler in a particular amount. In certain embodiments, the electrical conductivity is from 1 ohm to 100 mega-ohms.

The nanofibers can have a diameter from 10 nanometers to 100 microns.

### BRIEF DESCRIPTION OF THE DRAWINGS

A full understanding of the disclosed concept can be gained from the following description of the preferred embodiments when read in conjunction with the accompanying drawings in which:

FIG. 1 is schematic of a conventional electrospinning apparatus, in accordance with the prior art.

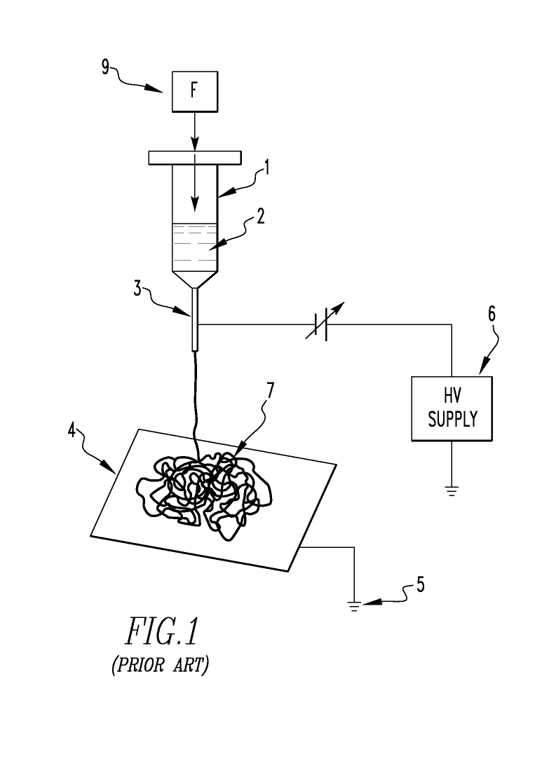

FIG. 2 is a schematic of a typical ForceSpinning™ apparatus, in accordance with the prior art.

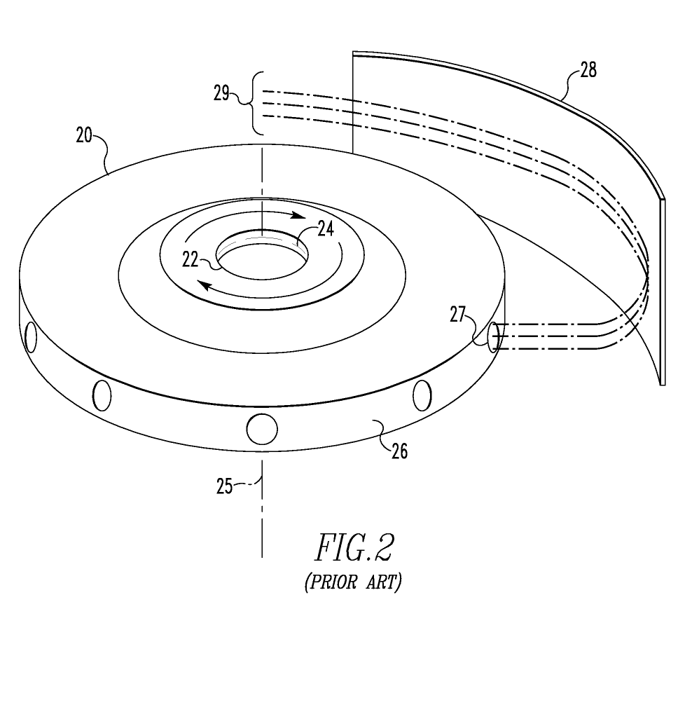

FIGS. 3A, B and C are schematics of a process for depositing nanofibers into a mold and subsequently onto a molded part, in accordance with certain embodiments of the disclosed concept.

### DESCRIPTION OF THE PREFERRED EMBODIMENTS

As employed herein, the tern “number” shall mean one or an integer greater than one (i.e., a plurality).

As employed herein, the statement that two or more parts are “connected” or “coupled” together shall mean that the parts are joined together either directly or joined through one or more intermediate parts. Further, as employed herein, the statement that two or more parts are “attached” shall mean that the parts are joined together directly.

The disclosed concept relates to an injection molded part having nanofibers deposited on an outer surface thereof. The injection molded part is generally formed by a conventional process which includes injecting a matrix composition into a mold, allowing the matrix composition to cool and/or set in the mold, and then extracting the molded part from the mold. In the disclosed concept, a surface of the mold is at least partially coated with nanofibers prior to injecting the matrix composition therein. Thus, when the matrix composition is injected and allowed to cool and/or set in the mold, the nanofibers from the surface of the mold are at least partially transferred to the surface of the molded part such that the property or functionality of the nanofibers is imparted to the surface of the injection molded part.

The nanofibers can be at least partially embedded in the molded part. In certain embodiments, the nanofibers may be completely embedded in the molded part. Further, in certain embodiments, the surface of the molded part can be laminated with the nanofibers. The nanofibers can form an at least partial layer or coating on at least a portion of the surface of the molded part.

In general, the nanofibers impart one or multiple functionality to the molded part. That is, the surface of the injection molded part including the nanofibers exhibits at least one property which is not exhibited, or exhibited in a lesser amount/degree, in the molded part when composed of only a matrix composition, e.g., a polymer matrix, in the absence of the nanofibers. The surface of the molded part exhibits properties at least similar to the properties of the nanofibers.

The nanofibers, e.g., composite nanofibers, are composed of a fiber material or composition and filler. The fiber composition can be selected from a wide variety of materials known in the art for producing nanofibers and includes polymer, polymer-containing materials, metal, metal-containing materials, inorganic materials and mixtures thereof. The inorganic materials can include ceramics.

The filler can also be selected from a wide variety of known materials. The filler is selected based on the property or properties that are desired to be imparted to the nanofibers and subsequently to the injection molded part. That is, the particular tiller selected exhibits the same property as that to be imparted to the resulting injection molded part. The specific composite filler material selected and the particular amount employed to produce the nanofibers can allow a desired property or functionality of the injection molded part to be controlled or customized.

In general, different filler materials will produce varying properties. For example, an electrically conductive filler material can be used to control the surface conductivity of the resulting molded part having the nanofibers at least partially coated thereon. In certain embodiments, the surface conductivity of the molded part can be controlled from about 1 ohm to about 100 mega-ohms. In another embodiment, magnetic properties can be imparted to the surface of the molded part by combining the nanofibers with fillers having magnetic properties. Thus, a matrix composition which has little or no electrical conductivity or magnetic properties can be utilized in an injection molding process to form a molded part that has an electrical conductivity or magnetic property (or improved electrical conductivity or magnetic property) as a result of the conductive or magnetic nanofibers deposited on the surface of the molded part.

In addition to imparting electrical conductivity and/or magnetic properties, the nanofibers are capable of imparting to the molded part functionality, such as but not limited to thermal conductivity, hydrophobicity, superhydrophobicity and combinations thereof.

Without intending to be bound by any particular theory, it is believed that the use of nano-scale fibers results in improved interaction and bonding between the fibers and the molded part. Further, it is believed that the property imparted by the nanofibers to the molded part is enhanced due to a higher surface area.

The nanofibers can be produced utilizing various conventional techniques known in the art. In certain embodiments, the nanofibers for use in the disclosed concept are produced utilizing electrospinning techniques. The electrospinning is typically carried out at ambient temperature and pressure conditions. In certain other embodiments, the nanofibers for use in the disclosed concept are produced utilizing ForceSpinning™ technology. The ForceSpinning™ is typically conducted at elevated temperature conditions, e.g., the melt temperature of the fiber composition which is used to form the nanofibers. Both electrospinning and ForceSpinning™ processes and apparatus are well known in the art.

In certain embodiments, the molded part is produced utilizing electrospinning or ForceSpinning™ techniques in conjunction with an injection molding process. For example, a hybrid electrospinning and injection molding process or ForceSpinning™ and injection molding process is used to produce composite nanofibers, and form an in-mold functional coating or layer on at least a portion of an outer surface of the molded part.

The nanofibers can be produced in an interconnected configuration so as to form a web or mat. The diameters of the nanofibers can vary and in certain embodiments, can be from about 10 nanometers to about 100 microns. Further, when the web or mat of nanofibers is attached or fused, e.g., deposited, on the surface of the molded part, without intending to be bound by any particular theory, it is believed that the nanofibers will not be easily removed, e.g., chipped or flaked off, of the molded part.

In accordance with certain embodiments of the disclosed concept, nanofibers can be formed on a collector substrate, such as a carrier film. The carrier film is attached or applied to the inner or interior surface of the mold, e.g., the surface of a cavity formed in the mold wherein the cavity has a shape which corresponds to the desired shape of the resulting molded part. The molding compound, e.g., matrix composition, is injected into the mold cavity and allowed to set or cure for a period of time. The molded part is then extracted from the mold. The outer or exterior surface of the molded part has incorporated, e.g., embedded or infused, at least partially thereon or therein the nanofibers, e.g., in the form of a layer or coating, which are at least partially transferred from the surface of the carrier film to the surface of the molded part. In alternate embodiments, the nanofibers can be formed directly on the inner or interior surface of the mold, e.g., the surface of a cavity formed in the mold, and the resulting molded part has incorporated thereon or therein the nanofibers which are at least partially transferred from the surface of the mold cavity to the surface of the molded part.

As previously described, the nanofibers can be in the form of a mat, e.g., nonwoven mat. The individual nanofibers in the mat can have a random orientation or can be predominantly oriented in one or more directions. The nanofiber mat can be flat and two-dimensional or three-dimensional depending on the shape and contours of the mold to which the nanofiber mat is being deposited or applied. The nanofiber mat is highly porous and therefore, the optical transparency of the molded component is not affected by the presence of the nanofiber mat embedded thereon or therein the surface of the molded part. This property is especially desirable for those applications wherein an optically transparent molded part is necessary.

The molded part is composed of polymer and/or polymer-containing materials, e.g., polymer matrix or polymer-containing matrix, known in the art. In certain embodiments, polymer and/or polymer-containing materials that are known for producing electrical apparatus are used. In certain embodiments, the matrix composition is transparent.

Further, in certain embodiments, as a result of depositing polymer composite nanofibers on a molded part to form a conducting media, surface conductivity can be added to flexible and deformable parts.

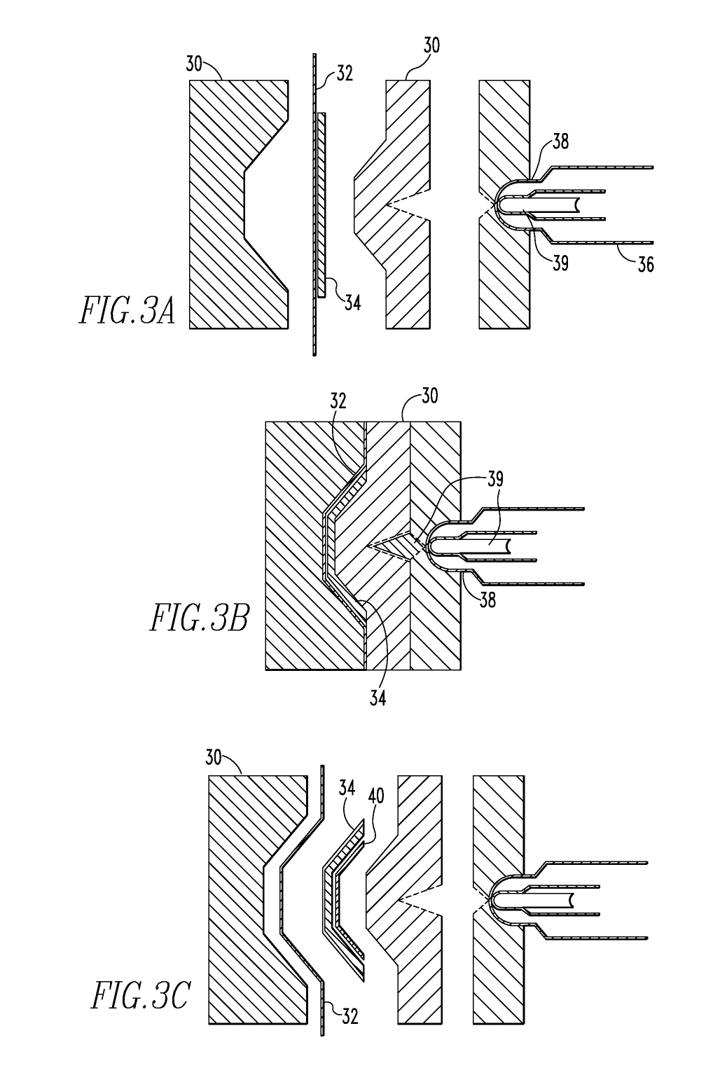

FIG. 3 illustrates an apparatus and process for depositing a coating of nanofibers on at least a portion of a surface of a molded part, in accordance with certain embodiments of the disclosed concept. As shown in FIG. 3A, a foil positioning step is employed to initiate the process. The apparatus for this step includes a die 30, a carrier film 32 and conducting nanofibers 34. The conducting nanofibers 34 are deposited onto the carrier film 32 and form a layer thereon. A nozzle 36 having a nozzle head 38 is used to inject material 39 into the die 30. Thus, the nozzle 36 includes the nozzle head 38 and the material 39 contained therein. The material 39 can include polymer or polymer-containing material, such as resin. FIG. 3B further shows an injection molding step which includes the carrier film 32 containing the conducting nanofibers 34 in contact with, e.g., attached or applied to, an interior surface of the die 30. The nozzle head 38 injects the material 39 into the die 30. FIG. 3C shows an extraction step wherein a molded part 40 is produced and an outer surface of the molded part 40 has deposited therein or thereon the conducting nanofibers 34 which are at least partially transferred from the carrier film 32 which is remaining on the interior surface of the die 30. The presence of the conducting nanofibers 34 on or in the surface of the molded part 40 allows the surface conductivity of the molded part 40 to be controlled or specified.

In certain embodiments, the compositions and methods of the disclosed concept can be carried out in the absence of a binder material and without pre-forming the nanofibers.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof.

What is claimed is:

1. A method for producing an injection molded part having nanofibers at least partially deposited on an outer surface thereof, comprising:
generating nanofibers which comprise:
a fiber material selected from the group consisting of polymer, polymer-containing material, metal, metal-containing material, inorganic material, and mixtures thereof; and
filler;
obtaining a mold having a cavity formed therein corresponding to a desired shape of the injection molded part;
depositing the nanofibers at least partially on a surface of the cavity;
injecting a matrix composition comprising polymer into the cavity;
allowing the matrix composition to set;
transferring the nanofibers at least partially from the surface of the cavity to the outer surface of the injection molded part; and
extracting the injection molded part from the mold.

2. The method of claim 1, wherein the mold and the injection molded part is three-dimensional.

3. The method of claim 1, wherein the fiber material and filler are combined at ambient temperature and pressure conditions.

4. The method of claim 1, wherein the fiber material and filler are combined at a melt temperature of the fiber material.

5. The method of claim 1, wherein the filler material exhibits properties selected from the group consisting of electrical conductivity and magnetic properties.

6. The method of claim 1, wherein thermal conductivity of the filler is higher than thermal conductivity of the fiber material and the second composition.

7. The method of claim 1, wherein the nanofibers are deposited on at least a portion of a collector substrate.

8. The method of claim 7, wherein the collector substrate is applied to the surface of the cavity and the nanofibers are at least partially transferred from the collector substrate to the outer surface of the injection molded part.

9. The method of claim 1, wherein the nanofibers are deposited directly on at least a portion of the surface of the cavity.

10. The method of claim 1, wherein the nanofibers are in the form of a mat.

11. The method of claim 10, wherein the mat is porous such that when the matrix composition is transparent the molded part formed therefrom and having the nanofibers deposited thereon is also transparent.

12. The method of claim 1, wherein the filler material exhibits at least one property selected from the group consisting of superhydrophobic property, hydrophobic property and combinations thereof.

13. The method of claim 10, wherein orientation of individual nanofibers in the mat is selected from the group consisting of randomly oriented, oriented in one direction and oriented in more than one direction.

14. An injection molded part, comprising:
a polymer-containing composition; and
nanofibers at least partially deposited on an outer surface of the injection molded part, the nanofibers imparting at least one property to the injection molded part and the nanofibers, comprising:
a fiber material selected from the group consisting of polymer, polymer-containing material, metal, metal-containing material, inorganic material, and mixtures thereof; and
filler.

15. The molded part of claim 14, wherein the functionality can be selected from the group consisting of electrical conductivity and magnetic properties, and combinations thereof.

16. The molded part of claim 14, wherein the method for forming the injection molded part, comprises:
obtaining a mold having a cavity formed therein which corresponds to a desired shape of the injection molded part;
depositing the nanofibers at least partially on a surface of the cavity;
injecting the matrix composition into the cavity;
allowing the matrix composition to set;
transferring the nanofibers at least partially from the surface of the cavity t be outer surface of the injection molded part; and
extracting the injection molded part from the mold.

17. The molded part of claim 14, wherein electrical conductivity of the outer surface of the injection molded part is controlled by pre-selecting specific filler in a particular amount.

18. The molded part of claim 17, wherein the electrical conductivity is from 1 ohm to 100 mega-ohms.

19. The molded part of claim 14, wherein the nanofibers have a diameter from 10 nanometers to 100 microns.
